(19) United States
(12) Patent Application Publication
(10) Pub. No.: US 2007/0209454 A1
(43) Pub. Date: Sep. 13, 2007

(54) Method for inspecting a pattern of paste which a dispenser forms on a substrate

(75) Inventors: Youn-jung Joo, Gyeonggi-do (KR); Kyu-yong Bang, Gyeonggi-do (KR); Jong-sang Kim, Paju-si (KR)

Correspondence Address: KED & ASSOCIATES, LLP, P.O. Box 221200, Chantilly, VA, 20153-1200, US

(73) Assignee: Top Engineering Co., Ltd.

(21) Appl. No.: 11/709,890

(22) Filed: Feb. 23, 2007

(30) Foreign Application Priority Data
Feb. 24, 2006 (KR) 10-2006-0018234

(51) Int. Cl. G01M 19/00; G01F 25/00

(52) U.S. Cl. 73/865.9; 73/865.8; 73/1.36

(57) ABSTRACT

There is provided a method for inspecting a pattern of paste which a dispenser forms on a substrate, including putting the substrate on a stage; dispensing the paste on the substrate according to a relative distance between a nozzle and a surface of the substrate which a measuring unit measures in real time; storing data on the relative distance which is obtained from the measuring unit; selecting a point corresponding to data falling outside the predetermined range from among the stored data and designating the selected point as an inspection point; translating the data falling outside the predetermined range into a positional value and moving a dispensing head to a position over the inspection point on the pattern of paste corresponding to the positional value; and inspecting at the inspection point if there exists a defect on a pattern of paste.

### BACKGROUND OF THE INVENTION

1. Field of the Invention

The present invention relates to a method for inspecting a pattern of paste which a dispenser forms on a substrate and more particularly to a method for detecting an inspecting point on a pattern of paste which a dispenser forms on a substrate.

2. Description of the Background Art

A liquid crystal display (LCD) is low in power consumption, relatively small in size, and excellent in image quality, compared to a bulky cathode ray tube (CRT) of the same screen size. The LCD has established a firm foothold on the market as a flat panel display for computers, transportation, communication, instrumentation and, with increasing importance for television.

A thin film transistor (TFT) LCD consists of a TFT array substrate and a color filter array substrate. The two are separated by 4-5 μm and form the sandwich for the liquid crystal layer. At the periphery of the display viewing area, a glue seal bonds the two substrates together and also prevents moisture and contamination from entering the LC fluid.

A dispenser dispenses a paste in a predetermined pattern on a substrate to manufacture the array on the substrate.

The dispenser includes a stage on which the substrate is put, a dispensing head on which to provide a nozzle through which the paste is dispensed, a head supporting frame on which to provide the dispensing head, and a controlling unit controlling a motor moving the head-supporting frame and a motor moving the dispensing head

A syringe, which contains the paste, is connected to the nozzle. Then the syringe connected to the nozzle is provided to the dispensing head.

The dispenser forms a pattern of paste on the substrate, while changing a relative distance between the substrate and the nozzle.

That is, while the paste is dispensed, the substrate is moved in one direction and the dispensing head on the head supporting frame is moved in the direction perpendicular to the direction in which the substrate is moved.

FIG. 1 is a perspective view illustrating a dispensing head of a conventional dispenser. FIGS. 2 and 3 are schematic views for describing how to inspect the pattern of paste formed on the substrate.

The conventional dispenser head 100, as shown in FIG. 1, includes a main block 102 provided to a head-supporting frame (not shown), a head block 104 on which to provide detachably a syringe containing the paste. a moving unit 103 moving horizontally back and forth the head block 104 in the direction perpendicular to the head supporting frame, and a nozzle (not shown) provided to the lowest part of the head block 104.

The moving unit 103 (not shown) includes an linear movement apparatus having a servomotor and an motor axis connected thereto. The moving unit 103 moves horizontally back and forth the head block 104 in the direction perpendicular to the head supporting frame to set up a position of the nozzle (not shown) relative to the substrate.

A first Z-axis motor 107 is provided to a upper part of the main block 102. The first Z-axis motor 107 adjusts the position of the nozzle by moving the moving unit 103 vertically. A second Z-axis motor 108 is provided to the main block 102. The second Z-axis motor 108 accurately adjusts a height of the nozzle to set up the distance between the nozzle and the substrate. The height of the nozzle may be adjusted using only the first Z-axis motor 107 without having to provide the second Z-axis motor 108 to the main block 102.

The nozzle is laterally moved by moving the main block 102 along the head supporting frame.

First and second sensors 109a and 109b are provided to one side of the head block 104. The first sensor 109a is provided in front of the nozzle in the direction in which the paste is dispensed. The first sensor 109a serves to detect a relative distance between the nozzle and the surface of the substrate while dispensing the paste on the substrate. The dispensing of the paste according to the relative distance between the nozzle and the surface of the substrate makes it possible to uniformly dispense the paste on the substrate. The second sensor 109b serves to measure a cross-sectional area of the paste dispensed in the specified pattern on the substrate.

A lens 109c is provided within the second sensor 109b to rotate from side to side. The second sensor 109b continuously emits a laser beam through the lens 109c toward the substrate “G” to scan the paste “P”. Thus, the second sensor 109b serves to measure the cross-sectional area of the paste dispensed on the substrate “G”.

A cross-sectional area at a predetermined point on the patter of paste is measured on the sample basis to inspect if a pattern of paste is properly formed on the substrate.

However, a problem with this conventional method lies in its failure to measure a cross-sectional area of paste at a random point on the pattern of paste which a defect may occur due to vibration.

In the conventional method, a point on the pattern of paste, where a defect occurs frequently on a statistical basis. is predetermined as the inspection point at which the cross-sectional area is measured to facilitate the test for the defective pattern of paste. So, it is difficult to detect the defective pattern of paste in a case where the defect occurs at a point other than the predetermined inspection point.

### BRIEF DESCRIPTION OF THE INVENTION

Therefore, an object of the present invention is to accurately locate an inspection point on a pattern of paste formed on a substrate.

According to an aspect of the present invention, there is provided a method for inspecting a pattern of paste which a dispenser forms on a substrate, including putting the substrate on a stage; dispensing the paste on the substrate according to a relative distance between a nozzle and a surface of the substrate which a measuring unit measures in real time; storing data on the relative distance which is obtained from the measuring unit; selecting a point corresponding to data falling outside the predetermined range from among the stored data and designating the selected point as an inspection point; translating the data falling outside the predetermined range into a positional value and moving a dispensing head to a position over the inspection point on the pattern of paste corresponding to the positional value; and inspecting at the inspection point if there exists a defect on a pattern of paste.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating a dispensing head of a conventional dispenser;

FIGS. 2 and 3 are schematic views for describing how to inspect the pattern of paste formed on a substrate;

FIG. 4 is a perspective view illustrating a dispenser;

FIG. 5 is a front view illustrating how the dispensing head according to the present invention dispenses a paste on the substrate “G”.

FIG. 6 is schematic views illustrating the predetermined inspection points at which the cross-sectional areas of the paste are measured according to the conventional method and the inspection points at which the cross-sectional areas of the paste are measured according to the present invention;

FIG. 7 is a graph showing that a distance between the nozzle and the surface of the substrate is measured in real time in response to a point on the pattern of paste formed on the substrate; and

FIG. 8 is a flow chart showing steps of inspecting the pattern of paste according to the present invention.

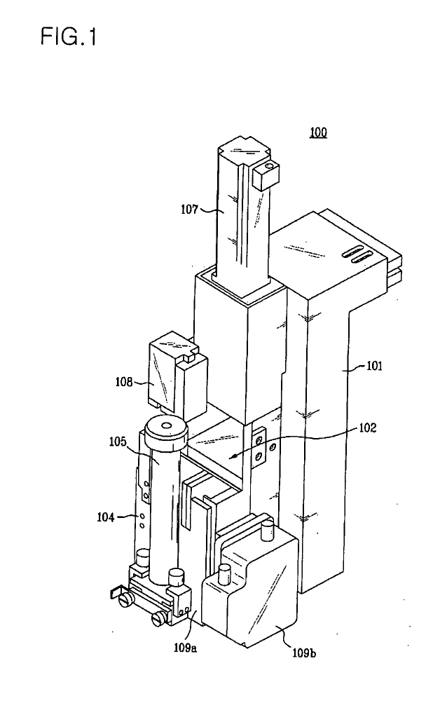

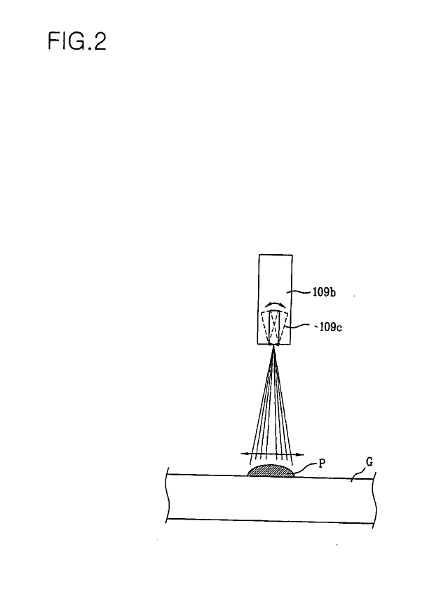

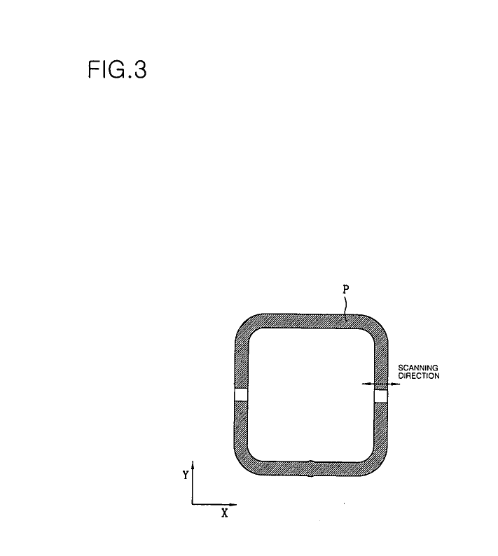

### DETAILED DESCRIPTION OF THE INVENTION

Reference will now be made in detail to the preferred embodiment of the present invention, an example of which is illustrated in the accompanying drawings.

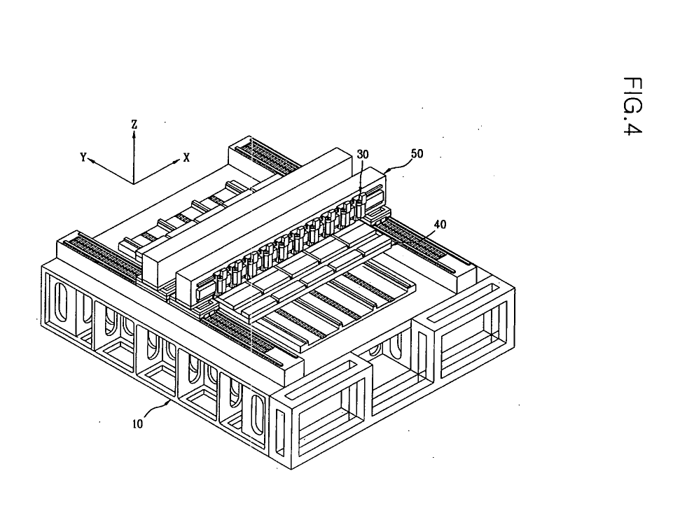

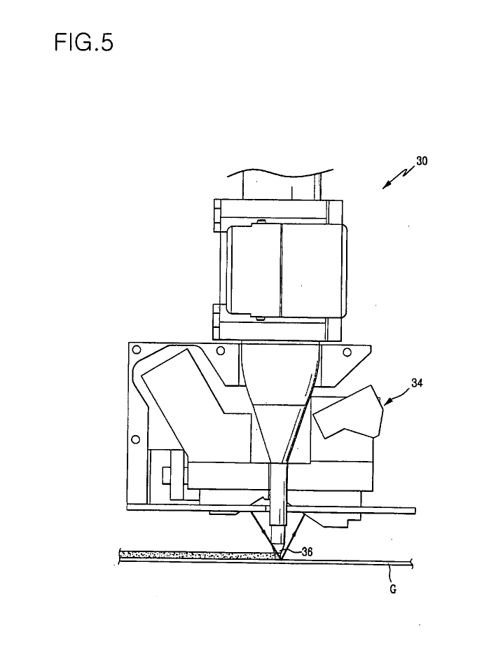

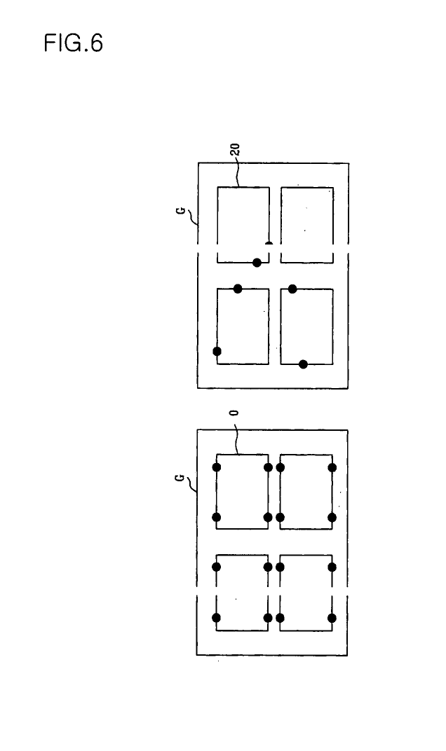

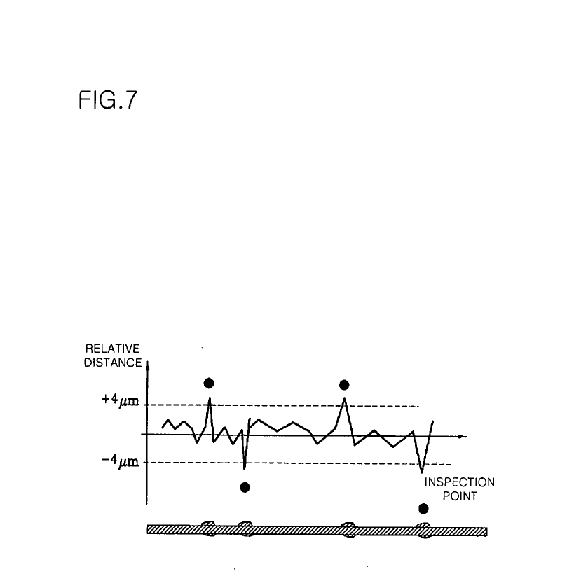

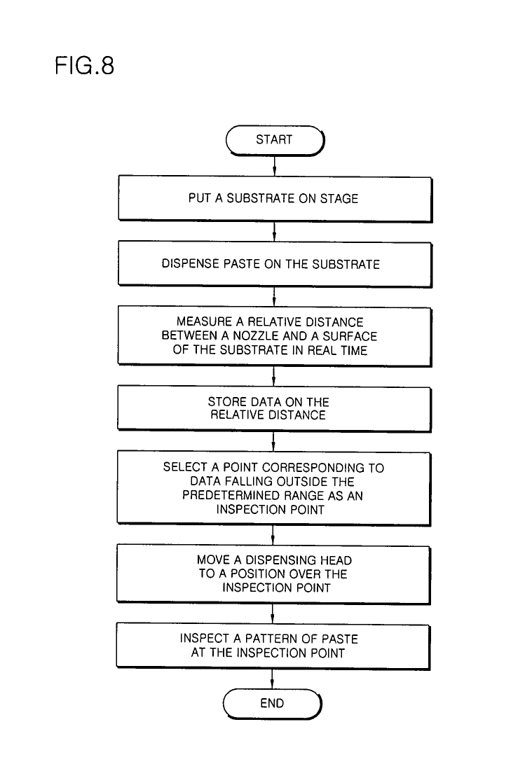

FIG. 4 is a perspective view illustrating the dispenser. FIG. 5 is a front view illustrating how the dispensing head according to the present invention dispenses the paste on the substrate “G”. FIG. 6 is schematic views illustrating the predetermined points at which the cross-sectional areas of the paste are measured according to the conventional method and the points at which the cross-sectional areas of the paste are measured according to the present invention, where the distance between the nozzle and the surface of the substrate is beyond the allowable range. FIG. 7 is a graph showing that a distance between the nozzle and the surface of the substrate is measured in real time in response to a point on the pattern of paste formed on the substrate. FIG. 8 is a flow chart showing steps of inspecting the pattern of paste according to the present invention.

The dispenser includes a body 10, a stage 40 provided to the body 10, on which the substrate is put, a stage-moving apparatus moving the stage 40 back and forth in the direction perpendicular to a head-supporting frame, a pair of head-supporting frames 50 which is moved back and forth along a length of the stage 10, a plurality of dispensing heads 30 provided to the head-supporting frame 50 to dispense the paste on the substrate “G” and a controlling unit (now shown) connected to the dispensing head 30 to control an amount of paste to be dispensed on the substrate.

The head-supporting frame 50 is a gantry-type frame. The dispensing head 30 includes a first sensor 34 measuring a distance between a nozzle through which to dispense the pasted and a surface of the substrate and a second sensor (not shown) measuring a cross-sectional area of the paste dispensed on the surface of the substrate.

The method for locating accurately an inspection point on a pattern of paste formed on a substrate according to the present invention is now described.

The two head-supporting frames 50 are moved in the opposing directions to allow the substrate “G” to be put on the stage 50 through a space between the two head-supporting frames 50.

The substrate “G” is held on the stage by sucking air through openings (not shown) formed on the stage.

The two head-supporting frames return to their original positions when the substrate “G” is held on the stage.

Then, a distance between a surface of the substrate “G” and an end point of the nozzle 36 is set to a predetermined value.

Thereafter, the paste is dispensed in the quadrangle pattern 20 on the surface of the substrate “G” while the stage 40 is moved by the stage moving apparatus in the direction perpendicular to the head-supporting frame and/or the dispensing head 30 on the head supporting frame 40 is moved along the head supporting frame.

The first sensor 34 is provided adjacent to the nozzle 36. The controlling unit (now shown), which is connected to the first sensor over wire or wireless, calculates the relative distance between the nozzle and the surface of the substrate “G” based on the data obtained by the first sensor 34. An amount of the paste corresponding to the relative distance is dispensed through the nozzle. This enables a uniform amount of paste to be dispensed on the substrate.

The data on the relative distance, obtained from the sensor 34, is transferred in real time to the controlling unit and stored there.

The second sensor measures the cross-sectional area of paste at the point on the pattern of paste, where the relative distance between the nozzle and the surface of the substrate is beyond the allowable range.

As shown in FIG. 7, the data on the relative distance obtained from the first sensor is translated into x- and y-coordinates of the point on the pattern of paste. The point at which the relative distance is beyond the allowable range is recognized as the point at which the cross-sectional area of the paste should be measured to check if there exists a defect on the pattern of paste.

The controlling unit moves the dispensing head 30 to a position over the inspection point at which the relative distance is beyond the allowable range. The cross-sectional area of paste at the inspection point is obtained by measuring the relative distance between the second sensor and the surface of the paste.

The cross-sectional area of paste is measured by the second sensor of the dispensing head only at the point where the relative distance is beyond the allowable range. This makes it possible to accurately detect a defective pattern of paste.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for inspecting a pattern of paste which a dispenser forms on a substrate, comprising:
putting the substrate on a stage;
dispensing the paste on the substrate according to a relative distance between a nozzle and a surface of the substrate which a measuring unit measures in real time;
storing data on the relative distance which is obtained from the measuring unit;
selecting a point corresponding to data falling outside the predetermined range from among the stored data and designating the selected point as an inspection point;
translating the data falling outside the predetermined range into a positional value and moving a dispensing head to a position over the inspection point on the pattern of paste corresponding to the positional value; and
inspecting at the inspection point if there exists a defect on a pattern of paste.

2. The method according to claim 1, wherein the measuring unit is a sensor which measures in real time the relative distance between the nozzle and the surface of the substrate and sends data on the relative distance to a controlling unit while dispensing the paste on the substrate.

3. The method according to claim 1, further comprising measuring a cross-sectional area of the paste at the inspection point to inspect if there exists a defect on the pattern of paste.
